(19) United States
(12) Patent Application Publication
(10) Pub. No.: US 2010/0007322 A1
(43) Pub. Date: Jan. 14, 2010

(54) RESISTOR UNIT AND A CIRCUIT INCLUDING THE RESISTOR UNIT

(75) Inventor: Li-Wei Huang, Taipei City (TW)

Correspondence Address: Stolowitz Ford Cowger LLP, 621 SW Morrison St, Suite 600, Portland, OR, 97205, US

(73) Assignee: Mobien Corporation, Taipei City (TW)

(21) Appl. No.: 12/352,553

(22) Filed: Jan. 12, 2009

(30) Foreign Application Priority Data
Jul. 10, 2008 (TW) 097126068

(51) Int. Cl. G05F 3/08; H01C 7/06

(52) U.S. Cl. 323/312; 338/9

(57) ABSTRACT

A resistor unit is adapted for use in a constant current source circuit or a temperature compensating circuit for providing temperature compensation to a constant voltage reference circuit. The resistor unit includes at least one first resistor, and at least one second resistor coupled to the first resistor. One of the first and second resistors is a positive temperature coefficient resistor. The other one of the first and second resistors is a negative temperature coefficient resistor. Because a temperature characteristic of the first resistor is opposite to that of the second resistor, an effective resistance of the resistor unit changes in a relatively narrower range with temperature.

### CROSS-REFERENCE TO RELATED APPLICATION

This application claims priority of Taiwanese Application No. 097126068, filed on Jul. 10, 2008 which is incorporated by reference in its entirety.

### BACKGROUND OF THE INVENTION

1. Field of the Invention

The present invention related to a resistor unit, more particularly to a resistor unit, suitable for temperature compensation applications.

2. Description of the Related Art

In a conventional constant current source circuit or constant voltage reference circuit, temperature compensation is provided to active elements (such as a metal-oxide-semiconductor field-effect transistor, a bipolar junction transistor, etc.), so as to obtain a stable current or voltage that is not affected by temperature. Referring to FIG. 1, a constant current (I_{R}) of a conventional constant current source circuit 9 is inversely proportional to a product of electron mobility μ of active elements and resistance of a resistor (R). However, the electron mobility μ changes with temperature. When the electron mobility μ decreases due to an increase in temperature, the constant current (I_{R}) increases if the resistor (R) is not designed for temperature compensation. Thus, a positive temperature coefficient (PTC) resistor (R) is generally provided in the conventional constant current circuit 9 for compensating a variance of the constant current (I_{R}) attributed to a change of the electron mobility μ of the active elements. In particular, although a decrease in the electron mobility μ will tend to cause the constant current (I_{R}) to increase when temperature increases, the resistance of the PTC resistor (R) will increase simultaneously so as to result in a tendency for the constant current (I_{R}) to decrease. Therefore, the conventional constant current source circuit 9 can provide a relatively stable constant current (I_{R}).

However, although the PTC resistor (R) is provided in the aforementioned conventional constant current circuit 9 for compensating a variance of the constant current (I_{R}) attributed to a change of the electron mobility μ of the active elements, it is possible that the constant current (I_{R}) is still unstable, because there is only a single one of the PTC resistor (R), and the resistance thereof may change excessively with temperature to result in over-compensation for the constant current (I_{R}).

### SUMMARY OF THE INVENTION

Therefore, an object of the present invention is to provide a resistor unit having an effective resistance that changes in a relatively narrower range with temperature, and a circuit including the resistor unit.

Accordingly, a resistor unit of the present invention comprises at least one first resistor, and at least one second resistor coupled to the first resistor. One of the first and second resistors is a positive temperature coefficient (PTC) resistor. The other one of the first and second resistors is a negative temperature coefficient (NTC) resistor.

Preferably, the resistor unit of the present invention is adapted for use in a constant current source circuit. The constant current source circuit is used to provide a constant current to a load coupled thereto, and comprises a first transistor, a second transistor, and the resistor unit. The first transistor has a drain terminal for receiving a reference current, a gate terminal coupled to the drain terminal, and a grounded source terminal. The second transistor has a gate terminal coupled to the gate terminal of the first transistor. The resistor unit is coupled to one of the drain terminal of the first transistor and a source terminal of the second transistor.

Preferably, the constant current source circuit further comprises a load transistor having a gate terminal coupled to a drain terminal of the second transistor, and a drain terminal adapted to be coupled to the load. The load transistor outputs an output current that is proportional to the constant current.

Additionally, the resistor unit of the present invention is adapted for use in a temperature compensating circuit for providing temperature compensation to a constant voltage reference circuit. The temperature compensating circuit comprises a first transistor, a second transistor, and the resistor unit. The first transistor has a grounded base terminal, a grounded collector terminal, and an emitter terminal adapted to be coupled to the constant voltage reference circuit for receiving a reference current therefrom. The second transistor has a grounded base terminal, a grounded collector terminal, and an emitter terminal adapted to be coupled to the constant voltage reference circuit for generating a current that is proportional to the reference current. The resistor unit couples the emitter terminal of one of the first and second transistors to the constant voltage reference circuit.

Because the temperature characteristic of the first resistor is opposite to that of the second resistor, an effective resistance of the resistor unit changes in a relatively narrower range with temperature so as to enable appropriate temperature compensation for the constant current source circuit or the constant voltage reference circuit.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic circuit diagram illustrating a conventional constant current source circuit;

FIG. 2 is a schematic circuit diagram illustrating a preferred embodiment of a constant current source circuit that incorporates a resistor unit according to the present invention;

FIG. 3 is a circuit diagram illustrating a preferred embodiment of a series type resistor unit according to the present invention;

FIG. 4 is a circuit diagram illustrating a preferred embodiment of a parallel type resistor unit according to the present invention;

FIG. 5 is a circuit diagram illustrating a preferred embodiment of a series-parallel type resistor unit according to the present invention; and

FIG. 6 is a schematic circuit diagram illustrating a preferred embodiment of a temperature compensating circuit that incorporates a resistor unit according to the present invention.

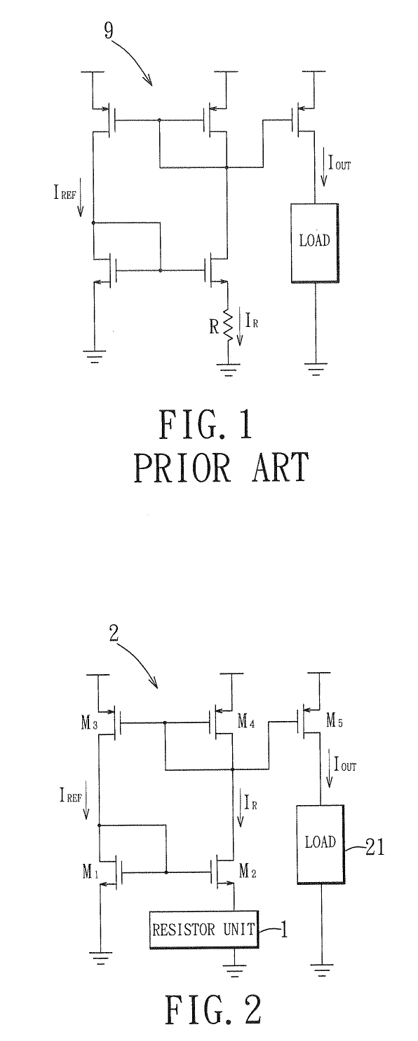

### DETAILED DESCRIPTION OF THE PREFERRED EMBODIMENTS

Before the present invention is described in greater detail, it should be noted that like elements are denoted by the same reference numerals throughout the disclosure.

Referring to FIG. 2, the resistor unit 1 according to the present invention is adapted for use in a constant current source circuit 2. In the constant current source circuit 2, a first transistor (M₁) has a drain terminal coupled to a third transistor (M₃), a gate terminal coupled to the drain terminal, and a grounded source terminal; and a second transistor (M₂) has a drain terminal coupled to a fourth transistor (M₄), a gate terminal coupled to the gate terminal of the first transistor (M₁), and a source terminal coupled to the resistor unit 1 in series. The constant current source circuit 2 further includes a fifth transistor (M₅) that serves as a load transistor and that has a gate terminal coupled to a drain terminal of the second transistor, and a drain terminal coupled to a load 21.

The drain terminal of the first transistor (M₁) receives a reference current (I_{REF}) from the third transistor (M₃). The third transistor (M₃) and the fourth transistor (M₄) have the same width-length ratio so as to enable generation of a constant current (I_{R}) at the second transistor (M₂) that is the same as the reference current (I_{REF}), i.e., I_{REF}=I_{R}. Moreover, the fourth transistor (M₄) and the fifth transistor (M₅) also have the same width-length ratio so as to enable generation of an output current (I_{OUT}) at the fifth transistor (M₅) that is the same as the constant current (I_{R}), i.e., I_{REF}=I_{R}=I_{OUT}, and that is provided to the load 21.

Since the gate terminal of the first transistor (M₁) is coupled to the gate terminal of the second transistor (M₂),

V_{GS1}=V_{GS2}+I_{R}R, (1)

wherein (R) is the resistance of the resistor unit 1, (V_{GS1}) is a gate-source voltage of the first transistor (M₁), and (V_{GS2}) is a gate-source voltage of the second transistor (M₂).

Additionally, a current of a transistor operating in a saturation region is:

I=½μₙCₒₓW/L(_{GS}−V_{TH})², (2)

wherein μₙ is electron mobility of the transistor, (Cₒₓ) is capacitance of an oxide layer, (W) is a width of the gate terminal, (L) is a length of the gate terminal, (V_{GS}) is a gate-source voltage of the transistor, and (V_{TH}) is a threshold voltage of the transistor.

A ratio of the width-length ratio of the first transistor (M₁) to the width-length ratio of the second transistor (M₂) is 1:N, i.e., (W/L)_{M2}=N(W/L)_{M1}. Therefore, according to Equation 2, the gate-source voltage (V_{GS1}) of the first transistor (M₁) is:

$${V}_{GS 1} = {[ \frac{2 \cdot {I}_{REF}}{{μ}_{n} {{C}_{ox} ( W / L )}_{M 1}} ]}^{1 / 2} + {V}_{TH 1} , \qquad ( 3 )$$

wherein (V_{TH1}) is a threshold voltage of the first transistor (M₁) ; and the gate-source voltage (V_{GS2}) of the second transistor (M₂) is:

$${V}_{GS 2} = {[ \frac{2 \cdot {I}_{R}}{{μ}_{n} {C}_{ox} {N ( W / L )}_{M 1}} ]}^{1 / 2} + {V}_{TH 2} , \qquad ( 4 )$$

wherein (V_{TH2}) is a threshold voltage of the second transistor (M₂).

Substitution of Equations 3 and 4 into Equation 1 gives:

$${[ \frac{2 \cdot {I}_{REF}}{{μ}_{n} {{C}_{ox} ( W / L )}_{M 1}} ]}^{1 / 2} + {V}_{TH 1} = {[ \frac{2 \cdot {I}_{R}}{{μ}_{n} {C}_{ox} {N ( W / L )}_{M 1}} ]}^{1 / 2} + {V}_{TH 2} + {I}_{R} \cdot R . \qquad ( 5 )$$

After rearranging Equation 5 based upon the aforementioned assumption, i.e., I_{REF}=I_{R}=I_{OUT}, the following equation can be obtained.

$${I}_{OUT} \approx \frac{2}{{μ}_{n} {{C}_{ox} ( W / L )}_{M 1}} \cdot \frac{1}{{R}^{2}} {( 1 - \frac{1}{{N}^{1 / 2}} )}^{2} \qquad ( 6 )$$

Wherein, it is assumed that a difference between (V_{TH1}) and (V_{TH2}) is negligible. From Equation 6, it is understood that the output current (I_{OUT}) is inversely proportional to a product of electron mobility μₙ of the transistors and the resistance (R) of the resistor unit 1. Other parameters are determined by manufacturers and designers.

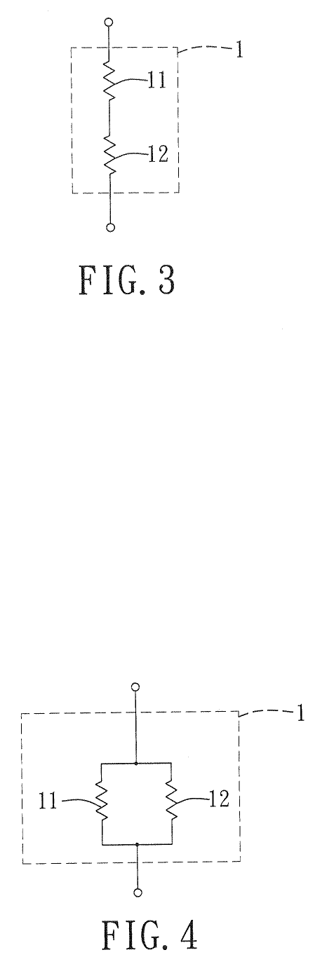

Generally, the temperature characteristic of a resistor is determined when the resistor is manufactured. A downstream manufacturer can only utilize the resistor, but not modify the temperature characteristic of the resistor. As mentioned hereinabove, a change in the resistance (R) of the resistor unit 1 directly affects the output current (I_{OUT}), i.e., the output current (I_{OUT}) will change if the resistance (R) of the resistor unit 1 changes with temperature. Therefore, referring to FIG. 3, the resistor unit 1 of this embodiment is a series type including a first resistor 11 and a second resistor 12 coupled in series, in order to solve the problem of excessive variation of the resistance of a single conventional resistor with temperature. The first resistor 11 is a positive temperature coefficient (PTC) resistor, whereas the second resistor 12 is a negative temperature coefficient (NTC) resistor. Resistances of the PTC first resistor 11 and the NTC second resistor 12 compensate each other, such that an effective resistance of the resistor unit 1 is relatively less sensitive to temperature compared to a single resistor, i.e., the effective resistance of the resistor unit 1 varies in a relatively narrower range with temperature.

Referring to FIG. 4, the resistor unit 1 of another embodiment of this invention is a parallel type including the first and second resistors 11, 12 coupled in parallel. The parallel type resistor unit 1 of this embodiment also works on the same principle that the variations in the resistances of the first and second resistors 11, 12 cancel out each other due to the opposing temperature characteristics thereof.

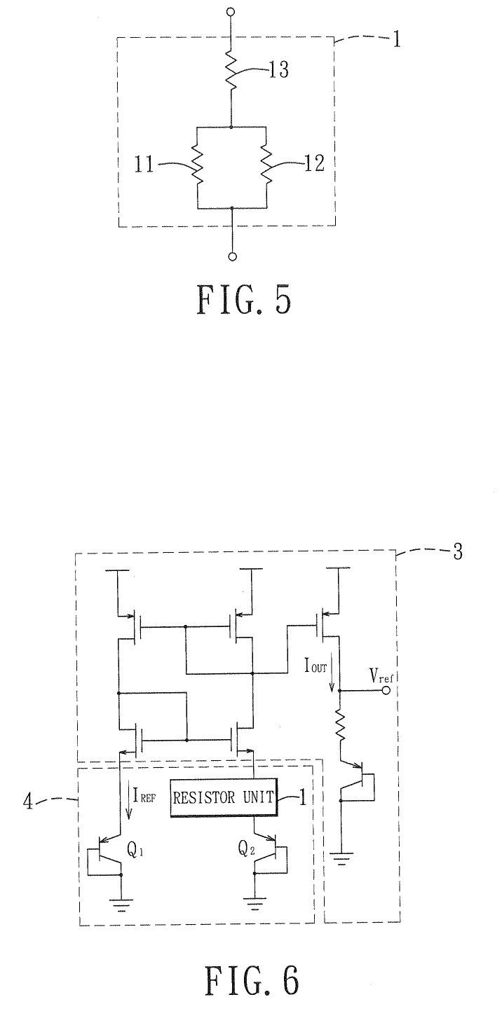

Furthermore, the resistor unit 1 of this invention can also be a combination of the series and parallel types (called series-parallel type in the following). As shown in FIG. 5, the resistor unit 1 includes the first resistor 11 and a pair of the second resistors 12 and 13. The second resistor 13 and a parallel combination of the first resistor 11 and the second resistor 12 are coupled in series. The working principle is that the variations in the resistances of the NTC second resistor 13 and the parallel type resistor unit 1 of FIG. 4 cancel out each other.

Referring to FIG. 6, the resistor unit 1 according to the present invention is adapted for use in a temperature compensating circuit 4 for providing temperature compensation to a constant voltage reference circuit 3. The temperature compensating circuit 4 includes a first transistor (Q₁), a second transistor (Q₂) and the resistor unit 1 according to the present invention. The first transistor (Q₁) has a grounded base terminal, a grounded collector terminal, and an emitter terminal coupled to the constant voltage reference circuit 3 for receiving a reference current (I_{REF}) therefrom. The second transistor (Q₂) has a grounded base terminal, a grounded collector terminal, and an emitter terminal coupled to the constant voltage reference circuit 3 for generating a current that is proportional to the reference current (I_{REF}). The resistor unit 1 couples the constant voltage reference circuit 3 to the emitter terminal of the second transistor (Q₂), but may couple the constant voltage reference circuit 3 to the emitter terminal of the first transistor (Q₁) in other embodiments of this invention. The resistor unit 1 of this embodiment can be any one of the aforementioned series, parallel and series-parallel types.

It is noted that the temperature characteristic of the resistor unit 1 can be modified according to requirements of users, and that the resistor unit 1 is not limited to the three aforementioned types. For example, the temperature characteristic of the resistor unit 1 in the constant current source circuit 2 is required to correspond with the electron mobility μₙ of the transistors. Since the electron mobility μₙ decreases when the temperature increases, the temperature characteristic of the resistor unit 1 is designed such that the effective resistance thereof increase when the temperature increases. Therefore, the constant current source circuit 2 can generate a relatively stable constant current (I_{R}).

In sum, the PTC first resistor 11 and the NTC second resistor 12 enable the resistor unit 1 of this invention to be suitable for providing appropriate temperature compensation due to the temperature characteristic thereof. This invention not only alleviates the problem associated with the inability to modify the temperature characteristic of the conventional resistor, but also enables the constant current source circuit 2 or the constant voltage reference circuit 3 to generate a relatively stable constant current or voltage.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A resistor unit comprising:
at least one first resistor; and
at least one second resistor coupled to said first resistor;
wherein one of said first and second resistors is a positive temperature coefficient (PTC) resistor, and the other one of said first and second resistors is a negative temperature coefficient (NTC) resistor.

2. The resistor unit as claimed in claim 1, wherein said resistor unit is adapted for use in a temperature compensating circuit that provides temperature compensation to a constant voltage reference circuit.

3. The resistor unit as claimed in claim 1, wherein said resistor unit is adapted for use in a constant current source circuit.

4. The resistor unit as claimed in claim 1, wherein said first and second resistors are coupled in series.

5. The resistor unit as claimed in claim 1, wherein said first and second resistors are coupled in parallel.

6. The resistor unit as claimed in claim 1, wherein said resistor unit comprises one said first resistor and a pair of said second resistors, one of said second resistors and a parallel combination of said first resistor and the other one of said second resistors being coupled in series.

7. A constant current source circuit comprising:
a first transistor for receiving a reference current;
a second transistor coupled to said first transistor for generating a constant current that is proportional to the reference current; and
a resistor unit coupled to one of said first and second transistors, said resistor unit including at least one first resistor, and at least one second resistor coupled to said first resistor;
wherein one of said first and second resistors is a positive temperature coefficient (PTC) resistor, and the other one of said first and second resistors is a negative temperature coefficient (NTC) resistor.

8. The constant current source circuit as claimed in claim 7, wherein:
said first transistor has a drain terminal for receiving the reference current, a gate terminal coupled to said drain terminal, and a grounded source terminal; and
said second transistor has a gate terminal coupled to said gate terminal of said first transistor.

9. The constant current source circuit as claimed in claim 8, wherein said resistor unit has one end coupled to a source terminal of said second transistor and another end that is grounded.

10. The constant current source circuit as claimed in claim 8, further comprising a load transistor having a gate terminal coupled to a drain terminal of said second transistor, and a drain terminal adapted to be coupled to a load, said load transistor outputting an output current that is proportional to the constant current.

11. The constant current source circuit as claimed in claim 7, wherein said first and second resistors are coupled in series.

12. The constant current source circuit as claimed in claim 7, wherein said first and second resistors are coupled in parallel.

13. The constant current source circuit as claimed in claim 7, wherein said resistor unit includes one said first resistor and a pair of said second resistors, one of said second resistors and a parallel combination of said first resistor and the other one of said second resistors being coupled in series.

14. A temperature compensating circuit for providing temperature compensation to a constant voltage reference circuit, said temperature compensating circuit comprising:
a first transistor having a grounded base terminal, a grounded collector terminal, and an emitter terminal adapted to be coupled to the constant voltage reference circuit for receiving a reference current therefrom;
a second transistor having a grounded base terminal, a grounded collector terminal, and an emitter terminal adapted to be coupled to the constant voltage reference circuit for generating a current that is proportional to the reference current; and
a resistor unit for coupling said emitter terminal of one of said first and second transistors to the constant voltage reference circuit, said resistor unit including at least one first resistor, and at least one second resistor coupled to said first resistor;
wherein one of said first and second resistors is a positive temperature coefficient (PTC) resistor, and the other one of said first and second resistors is a negative temperature coefficient (NTC) resistor.

15. The temperature compensating circuit as claimed in claim 14, wherein said first and second resistors are coupled in series.

16. The temperature compensating circuit as claimed in claim 14, wherein said first and second resistors are coupled in parallel.

17. The temperature compensating circuit as claimed in claim 14, wherein said resistor unit includes one said first resistor and a pair of said second resistors, one of said second resistors and a parallel combination of said first resistor and the other one of said second resistors being coupled in series.
